(19) United States
(12) Patent Application Publication
(10) Pub. No.: US 2024/0428361 A1
(43) Pub. Date: Dec. 26, 2024

(54) COORDINATED AND OPTIMIZED DISPATCHING METHOD FOR ELECTRIC BUSES

(71) Applicant: NANJING UNIVERSITY OF SCIENCE AND TECHNOLOGY, Nanjing (CN)

(72) Inventors: Yong QI, Nanjing (CN); Borong LUAN, Nanjing (CN); Zhuping ZHOU, Nanjing (CN); Liu HE, Nanjing (CN)

(21) Appl. No.: 18/681,976

(22) PCT Filed: Mar. 11, 2023
(86) PCT No.: PCT/CN2023/080951

§ 371 Date: Feb. 7, 2024

(30) Foreign Application Priority Data
Mar. 12, 2022 (CN) 202210240311.X

(51) Int. Cl. G06Q 50/40; G06Q 10/0631

(52) U.S. Cl. CPC G06Q 50/40; G06Q 10/06311

(57) ABSTRACT

The present disclosure provides a coordinated and optimized dispatching method for electric buses and belongs to the technical field of smart buses. The present disclosure allows for comprehensive optimization of an electric bus dispatching strategy in time and space dimensions, establishment of a bi-level programming model for bus dispatching with consideration of a bus capacity, a transfer problem, and characteristics of electric buses, and solving of the model by a genetic algorithm. The present disclosure enables generation of a dispatching strategy for electric buses encompassing time and space aspects. The dispatching strategy is closer to an actual passenger flow situation and has better actual benefits.

This patent application claims the benefit and priority of Chinese Patent Application No. 202210240311.X filed with the China National Intellectual Property Administration on Mar. 12, 2022, and entitled “COORDINATED AND OPTIMIZED DISPATCHING METHOD FOR ELECTRIC BUSES”, the disclosure of which is incorporated by reference herein in its entirety as part of the present application.

### TECHNICAL FIELD

The present disclosure relates to the technical field of smart buses, and in particular, to a coordinated and optimized dispatching method for electric buses.

### BACKGROUND

Public transport passenger flows have obvious time and space peak characteristics. A fixed single departure plan can hardly meet passenger flow requirements of a public transport line network. Thus, traveling plans need to be reorganized for different time periods and intervals between stops, and departure schedules for different lines are adjusted for transfer passenger flows. Cooperative dispatching is carried out for road network bus fleets. Specifically, in consideration of a number of passengers at stops, an overall service cost of buses, and the like, targeted dispatching strategies such as skipping over a stop and adding buses are implemented.

However, existing studies on bus dispatching mostly focus on conventional public traffic and are unadaptable to characteristics of electric buses. With the promotion of new energy vehicles in China, using pure electric buses in most urban public transportation is slipping into the mainstream. Therefore, running characteristics (such as a battery replacement cost, consumption of battery power by a time-varying passenger carrying capacity, and determination of a battery replacement demand) of electric buses need to be taken into account while restricting bus operation standards in dispatching. A dispatching optimization model may be established based on real-time passenger flows and solved to obtain an optimal operation plan, thus improving the benefits of an operator and passengers.

At present, electric bus operation and dispatching are mainly oriented to pure electric buses operating in a real-time charging mode. However, battery-replacing electric buses are used in many cities. The battery-replacing electric buses have the characteristics of stable electricity price, rapid operation without waiting for charging, low power waste, and the like, and there are few studies on bus operation optimization with respect to a battery replacement characteristic and a battery pack cost. For line network bus dispatching, existing plans are mostly intended to solely study a bus departure time table or a traveling mode, or to carry out static dispatching by combining selection of service stops and a departure frequency, resulting in a failure to well combine a time dimension and a space dimension of a departure schedule for the line network, and simultaneous optimization and global optimization cannot be realized. By existing multi-mode cooperative optimization for buses, a complete operation schedule cannot be output and dynamic fitting of real-time changes of passenger flows can also be hardly realized. How to carry out highly integrated dynamic cooperative dispatching in a multi-mode combined departure problem in the context of the line network still needs to be investigated.

### SUMMARY

In view of the defects and shortcomings of the prior art, an objective of the present disclosure is to provide a coordinated and optimized dispatching method for electric buses.

The technical solution of the coordinated and optimized dispatching method for electric buses provided in the present disclosure includes the following steps:
a data processing step: cleaning and preprocessing bus operation data of electric buses, line data, and passenger flow data, and collecting passenger flow origin and destination data; and
an optimized dispatching plan acquiring step: establishing a bi-level programming model based on the data obtained in the data processing step and solving the bi-level programming model using a genetic algorithm to acquire an optimal bus departure interval and an optimal bus stop schedule plan, where the bi-level programming model is composed of an upper-level model and a lower-level model, where the upper-level model is configured to optimize a bus stop schedule plan such that service time of all buses is as short as possible and an operation energy consumption cost is minimum, and an objective function thereof is as follows:

$$min f = α [ Δ + {\sum }_{l ∈ L} K {Q}_{l} + {\sum }_{l ∈ L , k ∈ K , i ∈ I} {φ}_{l , i}^{k} {S}_{l , i}^{k} ] + β [ {\sum }_{l ∈ L , k ∈ K , i ∈ I} {b}_{l , i}^{k} \cdot {R}_{l}^{k} \cdot {C}_{battery} ] , ∀ l ∈ L , i ∈ I , k ∈ K ;$$

where f represents an objective function value of the upper-level model; α and β represent normalized weighting coefficients, respectively, and α+β=1; Δ represents a total path traveling time of all buses; Qₗ represents a fixed service cost of a single trip of a single bus in line l; φ_{l,i}^{k} represents whether a kth bus skips over stop i in line l, where 1 represents not skipping over the stop, and 0 represents skipping over the stop; S_{l,i}^{k} represents a stopping time needed by the kth bus at stop i in line l; b_{l,i}^{k} represents a number of passengers getting on the kth bus at stop i in line l; Rₗ^{k} represents whether the kth bus in line l needs to replace a battery after the current shift, where if yes, Rₗ^{k}=1; otherwise, Rₗ^{k}=0; C_{battery} represents a single battery replacement cost of an electric bus; L represents a total number of lines of a bus road network; I represents a total number of stops of a corresponding bus line; and K represents a total number of electric buses in the corresponding bus line;
constraint conditions of the upper-level model are as follows:

$$\begin{matrix}{\sum }_{i ∈ I} [ 1 - {φ}_{l , i}^{k} ] {S}_{l , i}^{k} \leq {H}_{l , k} , ∀ l ∈ L , k > 1 ; \\ {φ}_{l , i}^{k} + {φ}_{l , i}^{k - 1} \geq 1 , ∀ l ∈ L , i ∈ I , k > 1 ; \\ {R}_{l}^{k} = \{ \begin{matrix}0 , {P}_{l}^{k} > {\sum }_{i ∈ I} {b}_{l , i}^{k} \cdot e \cdot d \\ 1 , {P}_{l}^{k} \leq {\sum }_{i ∈ I} {b}_{l , i}^{k} \cdot e \cdot d\end{matrix} , ∀ l ∈ L , i ∈ I , k ∈ K ; and \\ {H}_{l , k} \geq {t}_{b} , ∀ l ∈ L , i ∈ I , k > 1 ;\end{matrix}$$

where H_{l,k} represents a departure interval between the kth bus and a (k−1)th bus in line l; φ_{l,i}^{k-1} represents whether the (k−1)th bus skips over stop i in line l; Pₗ^{k} represents an energy efficacy coefficient per unit quantity of electricity for the kth bus in line l during traveling; e represents a battery power needed by a bus in a single shift for continuous full-load operation; d represents an average riding distance of all passengers; and t_{b} represents a battery replacement time of an electric bus;
the lower-level model is configured to optimize a bus departure interval and regulate a number of departures in a peak period to reduce a total waiting time of a passenger, and an objective function thereof is as follows:

$$min F = {\sum }_{1 \leq k \leq K - 2 , l ∈ L , i , j ∈ I} {w}_{l , ij}^{k} [ {Y}_{l , ij}^{k} + {X}_{l , ij}^{k} ] + {η}_{l , i}^{k} [ {t}_{l , i}^{k + 1} + ( 1 - {φ}_{l , i}^{k + 1} {φ}_{l , j}^{k + 1} ) {t}_{l , i}^{k + 2} ] ;$$

where F represents an objective function value of the lower-level model; w_{l,ij}^{k} represents a number of passengers who want to ride in the kth bus at stop i and get off at stop j in line l; Y_{l,ij}^{k} represents a riding time of a passenger who rides in the kth bus with an origin and destination of ij in line l; X_{l,ij}^{k} represents a waiting time of a passenger who rides in the kth bus with an origin and destination of ij in line l; η_{l,i}^{k} represents a number of stranded passengers who fail to ride in the kth bus due to a limited residual capacity at stop i in line l; t_{l,i}^{k+1} represents a time headway between the (k+1)th bus at stop i and the kth bus in line l; φ_{l,i}^{k+1} represents whether the (k+1)th bus skips over stop i in line l; φ_{l,j}^{k+1} represents whether the (k+1)th bus skips over stop j in line l; and t_{l,i}^{k+2} represents a time headway between the (k+2)th bus at stop i and the (k+1)th bus in line l; and
constraint conditions of the lower-level model are as follows:

$$\begin{matrix}{h}_{min} \leq {H}_{l , k} \leq {h}_{max} , ∀ l ∈ L , ∀ k ∈ K ; \\ 0 \leq {σ}_{l , m}^{k} \leq {h}_{max} , ∀ l , m ∈ L , ∀ k ∈ K ; \\ 0 \leq {ε}_{l , i}^{k} \leq C , ∀ l ∈ L , i ∈ I , k ∈ K ; and \\ {\sum }_{1 < k \leq K} {H}_{l , k} = M , ∀ l ∈ L ;\end{matrix}$$

where hₘᵢₙ and hₘₐₓ represent a minimum departure interval and a maximum departure interval, respectively; σ_{l,m}^{k} represents a transfer time taken by a passenger on the kth bus to transfer from line l to line m; ε_{l,i}^{k} represents a residual capacity of the kth bus at stop i in line l; C represents an approved number of passengers of a bus; and M represents a line network dispatching duration.

Further, the total path traveling time Δ of all buses may be calculated by the following formula:

$$Δ = {\sum }_{l ∈ L , k ∈ K , 1 < i \leq I} ( {δ}_{i - 1 , i} + 2 {φ}_{l , i}^{k} θ ) ;$$

where δ_{i-1,i} represents a bus traveling time along a path from stop i−1 to stop i; and θ represents a time taken by a bus to accelerate or decelerate at a stop.

Further, the number w_{l,ij}^{k} of passengers who want to ride in the kth bus at stop i and get off at stop j in line l may be calculated by the following formulas:

$$\begin{matrix}{w}_{l , ij}^{k} = {λ}_{l , ij} {t}_{l , i}^{k} + [ 1 - {φ}_{l , i}^{k - 1} {φ}_{l , j}^{k - 1} ] {w}_{l , ij}^{k - 1} , k > 1 ; \\ {t}_{l , i}^{k} = {T}_{l , i}^{k} - {T}_{l , i}^{k - 1} , k > 1 , i > 1 ; \\ {T}_{l , i}^{k} = {D}_{l , i - 1}^{k} + {δ}_{i - 1 , i} + {φ}_{l , i - 1}^{k} θ + {φ}_{l , i}^{k} θ , i > 1 ; \\ {D}_{l , i}^{k} = {T}_{l , i}^{k} + {φ}_{l , i}^{k} {S}_{l , i}^{k} , i > 1 ; \\ {D}_{l , 1}^{k} = {D}_{l , 1}^{1} + {\sum }_{{k}^{′} = 2}^{k} {H}_{l , {k}^{′}} , k > 1 ; and \\ {H}_{l , 1} = 0 ;\end{matrix}$$

where λ_{l,ij} represents a rate of arrival of a passenger who wants to get on at stop i and get off at stop j in line l; t_{l,i}^{k} represents a time headway between the kth bus at stop i and a (k−1)th bus in line l; φ_{l,i}^{k-1} represents whether the (k−1)th bus skips over stop i in line l; φ_{l,j}^{k-1} represents whether the (k−1)th bus skips over stop j in line l; w_{l,ij}^{k-1} represents a number of passengers who want to ride in the (k−1)th bus at stop i and get off at stop j in line l; T_{l,i}^{k} represents a time point when the kth bus arrives at stop i in line l; T_{l,i}^{k-1} represents a time point when the (k−1)th bus arrives at stop i in line l; D_{l,i-1}^{k} represents a time point when the kth bus leaves stop i−1 in line l; φ_{l,i-1}^{k} represents whether the kth bus skips over stop i−1 in line l; and D_{l,i}^{k} represents a time point when the kth bus leaves stop i in line l.

Further, the number b_{l,i}^{k} of passengers getting on the kth bus at stop i in line l may be calculated by the following formulas:

$$\begin{matrix}{b}_{l , i}^{k} = min \{ {\sum }_{j = i + 1}^{I} {w}_{l , ij}^{k} + max \{ {\sum }_{j = i + 1}^{I} {w}_{l , ij}^{k - 1} - {ε}_{l , i}^{k - 1} , 0 \} , {ε}_{l , i}^{k - 1} + {a}_{l , i}^{k} \} , k > 1 ; \\ {ε}_{l , i}^{k} = {ε}_{l , i - 1}^{k} - {φ}_{l , i}^{k} {b}_{l , i}^{k} + {φ}_{l , i}^{k} {a}_{l , i}^{k} , i > 1 ; \\ {ε}_{l , 1}^{k} = C - {φ}_{l , 1}^{k} {b}_{l , 1}^{k} ; and \\ {a}_{l , i}^{k} = {\sum }_{{i}^{′} = 1}^{i - 1} {w}_{l , {i}^{′} i}^{k} {φ}_{l , i}^{k} , i > 1 ;\end{matrix}$$

where ε_{l,i}^{k-1} represents a residual capacity of the (k−1)th bus at stop i in line l; and a_{l,i}^{k} represents a number of passengers getting off the (k)th bus at stop i in line l.

Further, the waiting time X_{l,ij}^{k} of a passenger who rides in the kth bus with an origin and destination of ij in line l may be calculated by the following formulas:

$$\begin{matrix}{X}_{l , ij}^{k} = \frac{1}{2} {t}_{l , i}^{k} + {t}_{l , i}^{k + 1} + \frac{1}{2} {ζ}_{l , m} {σ}_{l , m}^{k} ; and \\ {σ}_{l , m}^{k} = \begin{matrix}min \\ p ∈ K\end{matrix} \{ max \{ {T}_{m , i}^{p} - {T}_{l , i}^{k} , 0 \} \} ;\end{matrix}$$

where ζ_{l,m} represents a probability of a passenger in line l transferring to line m; and T_{m,i}^{p} represents a time point when the pth bus arrives at stop i in line m.

Further, the number η_{l,i}^{k} of stranded passengers who fail to ride in the kth bus due to a limited residual capacity at stop i in line l may be calculated by the following formula:

$${η}_{l , i}^{k} = max \{ {b}_{l , i}^{k} - {ε}_{l , i}^{k} , 0 \} .$$

Further, the solving the bi-level programming model using a genetic algorithm to acquire an optimal bus departure interval and an optimal bus stop schedule plan may include:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

The present disclosure has the following beneficial effects: the present disclosure allows for comprehensive optimization of an electric bus dispatching strategy in time and space dimensions; a complete, directly feasible time-space dispatching plan for operation of road network buses can be obtained, which includes time and space dimensions and is more convenient and efficient; and different levels of a model are combined to form a highly coupled tight model which has better global optimality than an isolated optimization model. The present disclosure takes into account a time table optimization problem in electric bus dispatching and has a real-time response characteristic. The present disclosure is capable of realizing dynamic control on bus dispatching, and has better robustness in coping with updating of actual transport capacity of a bus and better fitting for passenger flow changes of the line network. Compared with a traditional time table at regular departure intervals, the present disclosure has better matching performance and adaptability for irregular passenger flows, and realizes accurate transport capacity distribution, thus reducing resource waste. In the present disclosure, a dynamic cooperative dispatching model for electric buses that is added with a bus capacity constraint, recalculates a waiting duration of a transfer passenger flow, and takes into account the energy consumption cost of electric buses is established. The model is more accurate and practical. A line departure plan is optimized. The cost of an operator and the travel time of passengers are greatly reduced. Buses between a plurality of lines are arranged in a better manner so that passengers can transfer more conveniently. The present disclosure solves the problem of mismatching between dynamic passenger flows and bus transport capacity, enables the dispatching strategy to be closer to an actual passenger flow situation and have better actual benefits, and has wide use prospects in urban bus line networks.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a structural schematic diagram of a bi-level programming model used in the present disclosure; and

FIG. 2 is a flowchart of a genetic algorithm for optimization used in the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are merely a part rather than all the embodiments of the present disclosure. All other embodiments derived from the embodiments in the present disclosure by a person of ordinary skill in the art without creative efforts shall fall within the protection scope of the present disclosure.

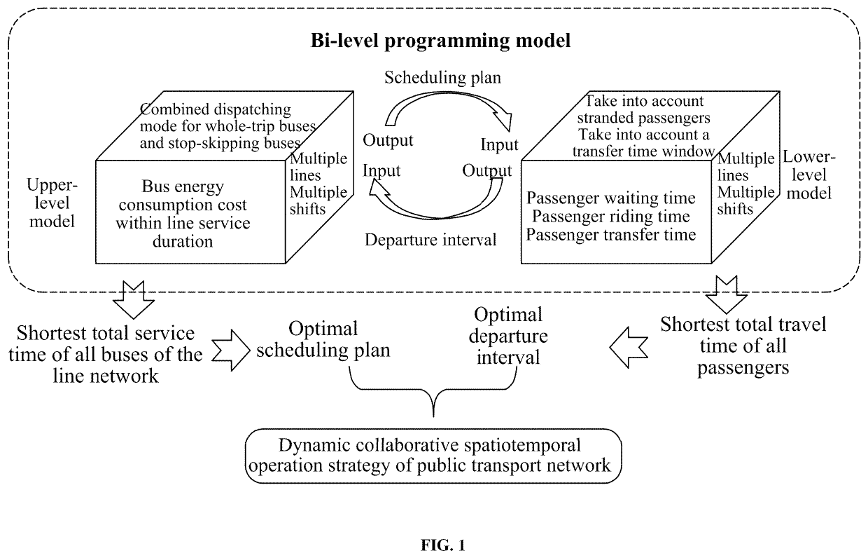

In an embodiment of the present disclosure, a bi-level programming model shown in FIG. 1 is mainly utilized to solve coordinated and optimized dispatching for electric buses, specifically including the following steps:

S1, bus operation data, line data, and passenger flow data of electric buses needed by a model algorithm are cleaned and preprocessed, and passenger flow OD (origin and destination) data is further collected based on integrated circuit (IC) card data.

S2, expression forms of variables (such as a total path traveling time Δ of all buses, a number w_{l,ij}^{k} of passengers who fail to get on a bus due to skipping over a stop, a waiting time X_{l,ij}^{k} of a passenger, a number η_{l,i}^{k} of stranded passengers, a time headway t_{l,i}^{k}, a number b_{l,i}^{k} of passengers getting on a bus, a number a_{l,i}^{k} of passengers getting off a bus, and whether a battery is replaced: R^{k}ₗ₎ required by the model are designed.

S3, an upper-level model in the bi-level programming model is established based on the data in S1 and the expression forms of the variables designed in S2. In the upper-level model, a bus stop schedule plan is optimized such that service time of all buses is as short as possible and an operation energy consumption cost is minimum.

S4, a lower-level model in the bi-level programming model is established based on the data in S1 and the expression forms of the variables designed in S2. In the lower-level model, a bus departure interval is optimized and a number of departures is regulated in a peak period to reduce a total waiting time of a passenger.

S5, algorithm parameters are initialized; and based on the bi-level programming model established in S3 and S4, a genetic algorithm is designed to solve the model to finally acquire an optimal bus dispatching plan.

Further, step S2 specifically includes the following steps.

S201, the total path traveling time Δ of all buses is calculated by:

$$Δ = {\sum }_{l ∈ L , k ∈ K , 1 < i \leq I} ( {δ}_{i - 1 , i} + 2 {φ}_{l , i}^{k} θ ) ;$$

where δ_{i-1,i} represents a bus traveling time along a path from stop i−1 to stop i; θ represents a time taken by a bus to accelerate or decelerate at a stop; and φ_{l,i}^{k} represents whether the kth bus skips over stop i in line l, where 1 represents not skipping over the stop, and 0 represents skipping over the stop.

S202, the number w_{l,ij}^{k} of passengers who want to ride in the kth bus at stop i and get off at stop j in line l is calculated by:

$$\begin{matrix}{w}_{l , ij}^{k} = {λ}_{l , ij} {t}_{l , i}^{k} + [ 1 - {φ}_{l , i}^{k - 1} {φ}_{l , j}^{k - 1} ] {w}_{l , ij}^{k - 1} , k > 1 ; \\ {t}_{l , i}^{k} = {T}_{l , i}^{k} - {T}_{l , i}^{k - 1} , k > 1 , i > 1 ; \\ {T}_{l , i}^{k} = {D}_{l , i - 1}^{k} + {δ}_{i - 1 , i} + {φ}_{l , i - 1}^{k} θ + {φ}_{l , i}^{k} θ , i > 1 ; \\ {D}_{l , i}^{k} = {T}_{l , i}^{k} + {φ}_{l , i}^{k} {S}_{l , i}^{k} , i > 1 ; \\ {D}_{l , 1}^{k} = {D}_{l , 1}^{1} + {\sum }_{{k}^{′} = 2}^{k} {H}_{l , {k}^{′}} , k > 1 ; and \\ {H}_{l , 1} = 0 ;\end{matrix}$$

where λ_{l,ij} represents a rate of arrival of a passenger who wants to get on at stop i and get off at stop j in line l; t_{l,i}^{k} represents a time headway between the kth bus at stop i and a (k−1)th bus in line l; φ_{l,i}^{k-1} represents whether the (k−1)th bus skips over stop i in line l; φ_{l,j}^{k-1} represents whether the (k−1)th bus skips over stop j in line l; w_{l,ij}^{k-1} represents a number of passengers who want to ride in the (k−1)th bus at stop i and get off at stop j in line l; T_{l,i}^{k} represents a time point when the kth bus arrives at stop i in line l; T_{l,i}^{k-1} represents a time point when the (k−1)th bus arrives at stop i in line l; D_{l,i-1}^{k} represents a time point when the kth bus leaves stop i−1 in line l; φ_{l,i-1}^{k} represents whether the kth bus skips over stop i−1 in line l; and D_{l,i}^{k} represents a time point when the kth bus leaves stop i in line l. H_{l,k} represents a departure interval between the kth bus and the (k−1)th bus in line l. S_{l,i}^{k} represents a stopping time needed by the kth bus at stop i in line l.

S203, the numbers b_{l,i}^{k} and a_{l,i}^{k} of passengers getting on and getting off the kth bus at stop i in line l is calculated by:

$$\begin{matrix}{b}_{l , i}^{k} = min \{ {\sum }_{j = i + 1}^{I} {w}_{l , ij}^{k} + max \{ {\sum }_{j = i + 1}^{I} {w}_{l , ij}^{k - 1} - {ε}_{l , i}^{k - 1} , 0 \} , {ε}_{l , i}^{k - 1} + {a}_{l , i}^{k} \} , k > 1 ; \\ {ε}_{l , i}^{k} = {ε}_{l , i - 1}^{k} - {φ}_{l , i}^{k} {b}_{l , i}^{k} + {φ}_{l , i}^{k} {a}_{l , i}^{k} , i > 1 ; \\ {ε}_{l , 1}^{k} = C - {φ}_{l , 1}^{k} {b}_{l , 1}^{k} ; and \\ {a}_{l , i}^{k} = {\sum }_{{i}^{′} = 1}^{i - 1} {w}_{l , {i}^{′} i}^{k} {φ}_{l , i}^{k} , i > 1 ;\end{matrix}$$

where ε_{l,i}^{k} represents a residual capacity of the kth bus at stop i in line l; ε_{l,i}^{k-1} represents a residual capacity of the (k−1)th bus at stop i in line l; a_{l,i}^{k} represents the number of passengers getting off the kth bus at stop i in line l; and C represents an approved number of passengers of a bus.

S204, an energy consumption cost C_{d} of an electric bus in a cycle is calculated by:

$${C}_{d} = {\sum }_{i ∈ I} {b}_{l , i}^{k} \cdot {R}_{l}^{k} \cdot {C}_{battery} .$$

For an electric bus, the energy consumption cost specifically refers to a battery replacement cost of the bus in the present disclosure, and battery loss is related to a real-time number of passengers. In the above formula, C_{battery} represents a single battery replacement cost (Yuan per time) of an electric bus; and Rₗ^{k} represents whether a bus needs to replace a battery after the current shift, and if yes, Rₗ^{k}=1; otherwise, Rₗ^{k}=0.

S205, a waiting time X_{l,ij}^{k} of a passenger who rides in the kth bus with an OD (origin and destination) of ij in line l is calculated by:

$$\begin{matrix}{X}_{l , ij}^{k} = \frac{1}{2} {t}_{l , i}^{k} + {t}_{l , i}^{k + 1} + \frac{1}{2} {ζ}_{l , m} {σ}_{l , m}^{k} ; \\ {σ}_{l , m}^{k} = \begin{matrix}min \\ p ∈ K\end{matrix} \{ max \{ {T}_{m , i}^{p} - {T}_{l , i}^{k} , 0 \} \} ;\end{matrix}$$

where ζ_{l,m} represents a probability of a passenger in line l transferring to line m; and T_{m,i}^{p} represents a time point when the pth bus arrives at stop i in line m. σ_{l,m}^{k} represents a transfer time taken by a passenger on the kth bus to transfer from line l to line m.

S206, the number η_{l,i}^{k} of stranded passengers who fail to ride in the kth bus due to a limited residual capacity at stop i in line l is calculated by:

$${η}_{l , i}^{k} = max \{ {b}_{l , i}^{k} - {ε}_{l , i}^{k} , 0 \} .$$

Further, step S3 specifically includes the following steps.

S301, an objective function of the upper-level model is established based on the data in S1 and the expression forms of the variables designed in S2.

$$min f = α [ Δ + {\sum }_{l ∈ L} K {Q}_{l} + {\sum }_{l ∈ L , k ∈ K , i ∈ I} {φ}_{l , i}^{k} {S}_{l , i}^{k} ] + β [ {\sum }_{l ∈ L , k ∈ K , i ∈ I} {b}_{l , i}^{k} \cdot {R}_{l}^{k} \cdot {C}_{battery} ] , ∀ l ∈ L , i ∈ I , k ∈ K ;$$

where Qₗ represents a fixed service cost of a single trip of a single bus in line l.

For this dual-objective nonlinear optimization problem, unified calculation is performed by selecting different weights for two objectives, thus achieving the effect of reducing the calculation quantity. α and β represent normalized weighting coefficients, respectively, and α+β=1.

S302, corresponding constraint conditions are added based on the objective function in S301:

To guarantee a time headway and not collide with a last bus, a travel time reduced by a bus by skipping over a stop during a trip cannot exceed the departure interval of this shift. Therefore, the following constraint is added for the objective function:

$${\sum }_{i ∈ I} [ 1 - {φ}_{l , i}^{k} ] {S}_{l , i}^{k} \leq {H}_{l , k} , ∀ l ∈ L , k > 1 .$$

To prevent that some passengers wait for a long time and cannot ride in a bus at a stop due to the stop being skipped over continuously, the following constraint is added to guarantee that each stop may not be skipped over continuously:

$${φ}_{l , i}^{k} + {φ}_{l , i}^{k - 1} \geq 1 , ∀ l ∈ L , i ∈ I , k > 1 .$$

The battery energy consumption of the pure electric bus is related to factors such as a traveling speed and a load of the bus. After each bus finishes the current shift, whether the bus needs to replace the battery is determined, and the following constraint is provided:

$${R}_{l}^{k} = \{ \begin{matrix}0 , {P}_{l}^{k} > {\sum }_{i ∈ I} {b}_{l , i}^{k} \cdot e \cdot d \\ 1 , {P}_{l}^{k} \leq {\sum }_{i ∈ I} {b}_{l , i}^{k} \cdot e \cdot d\end{matrix} , ∀ l ∈ L , i ∈ I , k ∈ K ;$$

where Pₗ^{k} represents an energy efficacy coefficient per unit quantity of electricity for the pure electric bus during traveling; e represents a battery power needed by a bus in a single shift for continuous full-load operation; and d represents an average riding distance of all passengers.

Buses possessed by a bus operator in the study area are all pure electric buses and operate in a battery replacement mode. An average battery replacement time is 10 min per time per vehicle. To prevent breakdown of a bus, it needs to guarantee that the departure interval between adjacent shifts is greater than the battery replacement time, and a constraint formula is as follows:

$${H}_{l , k} \geq {t}_{b} , ∀ l ∈ L , i ∈ I , k > 1 ;$$

where t_{b} represents the battery replacement time of the pure electric bus.

Further, step S4 specifically includes the following steps.

S401, an objective function of the lower-level model is established based on the data in S1 and the expression forms of the variables designed in S2.

$$min F = {\sum }_{1 \leq k \leq K - 2 , l ∈ L , i , j ∈ I} {w}_{l , ij}^{k} [ {Y}_{l , ij}^{k} + {X}_{l , ij}^{k} ] + {η}_{l , i}^{k} [ {t}_{l , i}^{k + 1} + ( 1 - {φ}_{l , i}^{k + 1} {φ}_{l , j}^{k + 1} ) {t}_{l , i}^{k + 2} ] ;$$

where Y_{l,ij}^{k} represents a riding time of a passenger who rides in the kth bus with an origin and destination of ij in line l.

S402, a corresponding constraint condition is added based on the objective function in S301:

$${h}_{min} \leq {H}_{l , k} \leq {h}_{max} , ∀ l ∈ L , ∀ k ∈ K ;$$

where hₘᵢₙ and hₘₐₓ represent a minimum departure interval and a maximum departure interval, respectively, which is obtained from historical data.

A transfer behavior at a transfer stop only within the maximum departure interval is approved, and otherwise, treated as two independent riding behaviors, for which the constraint is not calculated independently. Therefore, the following constraint is added:

$$0 \leq {σ}_{l , m}^{k} \leq {h}_{max} , ∀ l , m ∈ L , ∀ k ∈ K .$$

To guarantee that the residual capacity is within a reasonable range, the following constraint is set:

$$0 \leq {ε}_{l , m}^{k} \leq C , ∀ l ∈ L , i ∈ I , k ∈ K .$$

To ensure that there is a bus serving continuously in a line within an operation time range, the following constraint is added:

$${\sum }_{1 \leq k \leq K} {H}_{l , k} = M , ∀ l ∈ L ;$$

where M represents a line network dispatching duration.

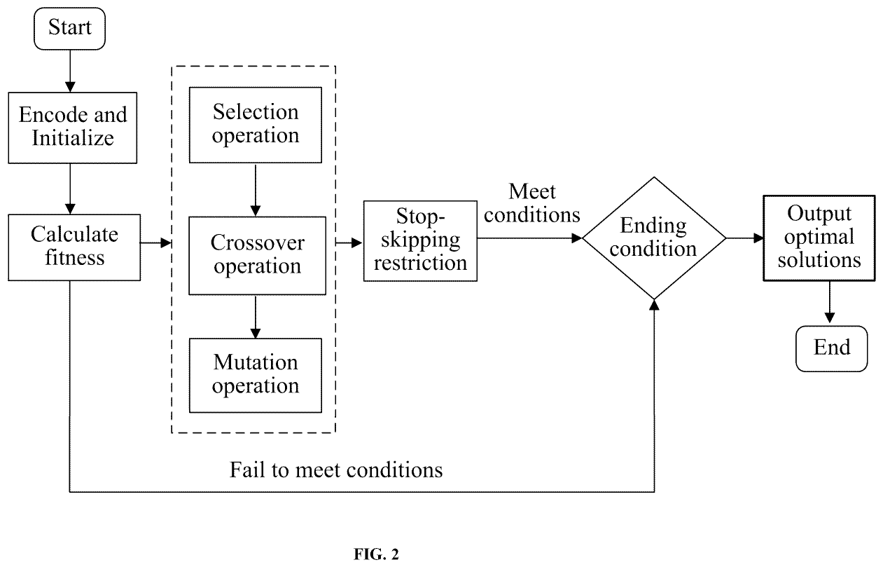

Further, step S5 specifically includes the following steps, as shown in FIG. 2.

S501, parameters are initialized. A maximum quantity pop of a population size is set and individuals of the bus departure interval and the bus stop schedule plan are randomly generated; and then a maximum number max of generations is set and a generation counter is set to 1.

S502, encoding and initial solving are performed. Variables departure interval and stop schedule plan are encoded and genes of chromosomes are formed with random initial values. If the variables meet the constraint conditions, S503 is performed. If the variables do not meet the constraint conditions, initial solutions are regenerated.

S503, calculation and selection are performed. Fitness values of all chromosomes are calculated. Chromosomes are selected by roulette wheel selection. If a fitness of a current generation of chromosomes is higher than a fitness of a previous generation, the current generation of chromosomes is maintained as current optimal solutions. If the fitness of the current generation of chromosomes is lower than the fitness of the previous generation, the current generation of chromosomes is not selected.

S504, reproduction is performed. Next generation of individuals is generated by the current chromosomes through crossover and mutation behaviors. If each individual meets the constraint conditions, S505 is performed; and if each individual does not meet the constraint conditions, new individuals are reproduced.

S505, if a current number of generations is equal to max, circulation is ended to obtain optimal solutions. If the current number of generations does not reach max, step S503 is performed again.

The embodiments are described herein in a progressive manner. Each embodiment focuses on the difference from another embodiment, and the same and similar parts between the embodiments may refer to each other.

Specific examples are used herein for illustration of the principles and embodiments of the present disclosure. The description of the foregoing embodiments is used to help illustrate the method of the present disclosure and the core principles thereof. In addition, those of ordinary skill in the art can make various modifications in terms of specific embodiments and scope of application in accordance with the teachings of the present disclosure. In conclusion, the contents of the present description shall not be construed as limitations to the present disclosure.

1. A coordinated and optimized dispatching method for electric buses, comprising:
a data processing step: cleaning and preprocessing bus operation data of electric buses, line data, and passenger flow data, and collecting passenger flow origin and destination data; and
an optimized dispatching plan acquiring step: establishing a bi-level programming model based on the data obtained in the data processing step and solving the bi-level programming model using a genetic algorithm to acquire an optimal bus departure interval and an optimal bus stop schedule plan, wherein the bi-level programming model is composed of an upper-level model and a lower-level model, wherein the upper-level model is configured to optimize a bus stop schedule plan such that service time of all buses is as short as possible and an operation energy consumption cost is minimum, and an objective function thereof is as follows:
$$min f = α [ Δ + {\sum }_{l ∈ L} {KQ}_{l} + {\sum }_{l ∈ L , k ∈ K , i ∈ I} {φ}_{l , i}^{k} {S}_{l , i}^{k} ] + β [ {\sum }_{l ∈ L , k ∈ K , i ∈ I} {b}_{l , i}^{k} \cdot {R}_{l}^{k} \cdot {C}_{battery} ] , ∀ l ∈ L , i ∈ I , k ∈ K ;$$
wherein α and β represent normalized weighting coefficients, respectively, and α+β=1; Δ represents a total path traveling time of all buses; Qₗ represents a fixed service cost of a single trip of a single bus in line l; of represents whether a kth bus skips over stop i in line l, wherein 1 represents not skipping over the stop, and 0 represents skipping over the stop; S_{l,i}^{k} represents a stopping time needed by the kth bus at stop i in line l; b_{l,i}^{k} represents a number of passengers getting on the kth bus at stop i in line l; Rₗ^{k} represents whether the kth bus in line l needs to replace a battery after the current shift, wherein if yes, Rₗ^{k}=1; otherwise, Rₗ^{k}=0; C_{battery} represents a single battery replacement cost of an electric bus; L represents a total number of lines of a bus road network; I represents a total number of stops of a corresponding bus line; and K represents a total number of electric buses in the corresponding bus line;
constraint conditions of the upper-level model are as follows:
$$\begin{matrix}{\sum }_{i ∈ I} [ 1 - {φ}_{l , i}^{k} ] {S}_{l , i}^{k} \leq {H}_{l , k} , ∀ l ∈ L , k > 1 ; \\ {φ}_{l , i}^{k} + {φ}_{l , i}^{k - 1} \geq 1 , ∀ l ∈ L , i ∈ I , k > 1 ; \\ {R}_{l}^{k} = \{ \begin{matrix}0 , {P}_{l}^{k} > {\sum }_{i ∈ I} {b}_{l , i}^{k} \cdot e \cdot d \\ 1 , {P}_{l}^{k} \leq {\sum }_{i ∈ I} {b}_{l , i}^{k} \cdot e \cdot d\end{matrix} , ∀ l ∈ L , i ∈ I , k ∈ K ; and \\ {H}_{l , k} \geq {t}_{b} , ∀ l ∈ L , i ∈ I , k > 1 ;\end{matrix}$$
wherein H_{l,k} represents a departure interval between the kth bus and a (k−1)th bus in line l; φ_{l,i}^{k-1} represents whether the (k−1)th bus skips over stop i in line l; Pₗ^{k} represents an energy efficacy coefficient per unit quantity of electricity for the kth bus in line l during traveling; e represents a battery power needed by a bus in a single shift for continuous full-load operation; d represents an average riding distance of all passengers; and t_{b} represents a battery replacement time of an electric bus;
the lower-level model is configured to optimize a bus departure interval and regulate a number of departures in a peak period to reduce a total waiting time of a passenger, and an objective function thereof is as follows:
$$min F = {\sum }_{1 \leq k \leq K - 2 , l ∈ L , i , j ∈ I} {w}_{l , ij}^{k} [ {Y}_{l , ij}^{k} + {X}_{l , ij}^{k} ] + {η}_{l , i}^{k} [ {t}_{l , i}^{k + 1} + ( 1 - {φ}_{l , i}^{k + 1} {φ}_{l , j}^{k + 1} ) {t}_{l , i}^{k + 2} ] ;$$
wherein w_{l,ij}^{k} represents a number of passengers who want to ride in the kth bus at stop i and get off at stop j in line l; Y_{l,ij}^{k} represents a riding time of a passenger who rides in the kth bus with an origin and destination of ij in line l; X_{l,ij}^{k} represents a waiting time of a passenger who rides in the kth bus with an origin and destination of ij in line l; η_{l,i}^{k} represents a number of stranded passengers who fail to ride in the kth bus due to a limited residual capacity at stop i in line l; t_{l,i}^{k+1} represents a time headway between the (k+1)th bus at stop i and the kth bus in line l; φ_{l,i}^{k+1} represents whether the (k+1)th bus skips over stop i in line l; φ_{l,j}^{k+1} represents whether the (k+1)th bus skips over stop j in line l; and t_{l,i}^{k+2} represents a time headway between the (k+2)th bus at stop i and the (k+1)th bus in line l; and
constraint conditions of the lower-level model are as follows:
$$\begin{matrix}{h}_{min} \leq {H}_{l , k} \leq {h}_{max} , ∀ l ∈ L , ∀ k ∈ K ; \\ 0 \leq {σ}_{l , m}^{k} \leq {h}_{max} , ∀ l , m ∈ L , ∀ k ∈ K ; \\ 0 \leq {ε}_{l , i}^{k} \leq C , ∀ l ∈ L , i ∈ I , k ∈ K ; and \\ {\sum }_{1 < k \leq K} {H}_{l , k} = M , ∀ l ∈ L ;\end{matrix}$$
wherein hₘᵢₙ and hₘₐₓ represent a minimum departure interval and a maximum departure interval, respectively; σ_{l,m}^{k} represents a transfer time taken by a passenger on the kth bus to transfer from line l to line m; ε_{l,i}^{k} represents a residual capacity of the kth bus at stop i in line l; C represents an approved number of passengers of a bus; and M represents a line network dispatching duration.

2. The coordinated and optimized dispatching method for electric buses according to claim 1, wherein the total path traveling time Δ of all buses is calculated by the following formula:
$$Δ = {\sum }_{l ∈ L , k ∈ K , 1 < i \leq I} ( {δ}_{i - 1 , i} + 2 {φ}_{l , i}^{k} θ ) ;$$
wherein δ_{i-1,i} represents a bus traveling time along a path from stop i−1 to stop i; and θ represents a time taken by a bus to accelerate or decelerate at a stop.

3. The coordinated and optimized dispatching method for electric buses according to claim 2, wherein the number w_{l,ij}^{k} of passengers who want to ride in the kth bus at stop i and get off at stop j in line l is calculated by the following formulas:
$$\begin{matrix}{w}_{l , ij}^{k} = {λ}_{l , ij} {t}_{l , i}^{k} + [ 1 - {φ}_{l , i}^{k - 1} {φ}_{l , j}^{k - 1} ] {w}_{l , ij}^{k - 1} , k > 1 ; \\ {t}_{l , i}^{k} = {T}_{l , i}^{k} - {T}_{l , i}^{k - 1} , k > 1 , i > 1 ; \\ {T}_{l , i}^{k} = {D}_{l , i - 1}^{k} + {δ}_{i - 1 , i} + {φ}_{l , i - 1}^{k} θ + {φ}_{l , i}^{k} θ , i > 1 ; \\ {D}_{l , i}^{k} = {T}_{l , i}^{k} + {φ}_{l , i}^{k} {S}_{l , i}^{k} , i > 1 ; \\ {D}_{l , 1}^{k} = {D}_{l , 1}^{1} + {\sum }_{{k}^{′} = 2}^{k} {H}_{l , {k}^{′}} , k > 1 ; and \\ {H}_{l , 1} = 0 ;\end{matrix}$$
wherein λ_{l,ij} represents a rate of arrival of a passenger who wants to get on at stop i and get off at stop j in line l; t_{l,i}^{k} represents a time headway between the kth bus at stop i and the (k−1)th bus in line l; φ_{l,i}^{k-1} represents whether the (k−1)th bus skips over stop i in line l; φ_{l,j}^{k-1} represents whether the (k−1)th bus skips over stop j in line l; w_{l,ij}^{k-1} represents a number of passengers who want to ride in the (k−1)th bus at stop i and get off at stop j in line l; T_{l,i}^{k} represents a time point when the kth bus arrives at stop i in line l; T_{l,i}^{k-1} represents a time point when the (k−1)th bus arrives at stop i in line l; D_{l,i-1}^{k} represents a time point when the kth bus leaves stop i−1 in line l; φ_{l,i-1}^{k} represents whether the kth bus skips over stop i−1 in line l; and D_{l,i}^{k} represents a time point when the kth bus leaves stop i in line l.

4. The coordinated and optimized dispatching method for electric buses according to claim 3, wherein the number b_{l,i}^{k} of passengers getting on the kth bus at stop i in line l is calculated by the following formulas:
$$\begin{matrix}{b}_{l , i}^{k} min \{ {\sum }_{j = i + 1}^{I} {w}_{l , ij}^{k} + max \{ {\sum }_{j = i + 1}^{I} {w}_{l , ij}^{k - 1} - {ε}_{l , i}^{k - 1} , 0 \} , {ε}_{l , i}^{k - 1} + {a}_{l , i}^{k} \} , k > 1 ; \\ {ε}_{l , i}^{k} = {ε}_{l , i - 1}^{k} - {φ}_{l , i}^{k} {b}_{l , i}^{k} + {φ}_{l , i}^{k} {a}_{l , i}^{k} , i > 1 ; \\ {ε}_{l , 1}^{k} = C - {φ}_{l , 1}^{k} {b}_{l , 1}^{k} ; and \\ {a}_{l , i}^{k} = {\sum }_{{i}^{′} = 1}^{i - 1} {w}_{l , {i}^{′} i}^{k} {φ}_{l , i}^{k} , i > 1 ;\end{matrix}$$
wherein ε_{l,i}^{k-1} represents a residual capacity of the (k−1)th bus at stop i in line l; and a_{l,i}^{k} represents a number of passengers getting off the (k)th bus at stop i in line l.

5. The coordinated and optimized dispatching method for electric buses according to claim 3, wherein the waiting time X_{l,ij}^{k} of a passenger who rides in the kth bus with an origin and destination of ij in line l is calculated by the following formulas:
$${X}_{l , ij}^{k} = \frac{1}{2} {t}_{l , i}^{k} + {t}_{l , i}^{k + 1} + \frac{1}{2} {ζ}_{l , m} {σ}_{l , m}^{k} ; and {σ}_{l , m}^{k} = \begin{matrix}min \\ p ∈ K\end{matrix} \{ max \{ {T}_{m , i}^{p} - {T}_{l , i}^{k} , 0 \} \} ;$$
wherein ζ_{l,m} represents a probability of a passenger in line l transferring to line m; and T_{m,i}^{p} represents a time point when the pth bus arrives at stop i in line m.

6. The coordinated and optimized dispatching method for electric buses according to claim 4, wherein the number η_{l,i}^{k} of stranded passengers who fail to ride in the kth bus due to a limited residual capacity at stop i in line l is calculated by the following formula:
$${η}_{l , i}^{k} = max \{ {b}_{l , i}^{k} - {ε}_{l , i}^{k} , 0 \} .$$

7. The coordinated and optimized dispatching method for electric buses according to claim 1, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

8. The coordinated and optimized dispatching method for electric buses according to claim 2, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

9. The coordinated and optimized dispatching method for electric buses according to claim 3, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

10. The coordinated and optimized dispatching method for electric buses according to claim 4, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

11. The coordinated and optimized dispatching method for electric buses according to claim 5, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.

12. The coordinated and optimized dispatching method for electric buses according to claim 6, wherein the solving the bi-level programming model using a genetic algorithm to acquire an optimal bus departure interval and an optimal bus stop schedule plan comprises:
a parameter initializing step: setting a maximum quantity pop of a population size and randomly generating individuals of the bus departure interval and the bus stop schedule plan, and then setting a maximum number max of generations and setting a generation counter to 1;
an encoding and initial solving step: encoding variables departure interval and stop schedule plan and forming genes of chromosomes with random initial values; if the variables meet the constraint conditions, proceeding to a calculation and selection step; if the variables do not meet the constraint conditions, regenerating initial solutions;
the calculation and selection step: calculating fitness values of all chromosomes; selecting chromosomes by roulette wheel selection; if a fitness of a current generation of chromosomes is higher than a fitness of a previous generation, maintaining the current generation of chromosomes as current optimal solutions; and if the fitness of the current generation of chromosomes is lower than the fitness of the previous generation, not selecting the current generation of chromosomes;
a reproduction step: generating next generation of individuals by the current chromosomes through crossover and mutation behaviors; if each individual meets the constraint conditions, proceeding to an ending step; and if each individual does not meet the constraint conditions, reproducing new individuals; and
the ending step: if a current number of generations is equal to max, ending circulation to obtain optimal solutions; and if the current number of generations does not reach max, returning to the calculation and selection step.
